(19) United States
(12) Patent Application Publication
(10) Pub. No.: US 2015/0069676 A1
(43) Pub. Date: Mar. 12, 2015

(54) EXOTHERMIC CUTTING BLADE

(71) Applicant: Eric Peterson, Phelan, CA (US)

(72) Inventor: Eric Peterson, Phelan, CA (US)

(21) Appl. No.: 14/023,708

(22) Filed: Sep. 11, 2013

(51) Int. Cl. B23K 35/02; B23K 7/00

(52) U.S. Cl. CPC B23K 35/0216; B23K 7/00
USPC 266/48

(57) ABSTRACT

An improved sacrificial exothermic cutting blade to be coupled to a standard oxygen exothermic cutting torch to cut material on land and under water. The improved cutting rod includes a semi-flattened outer tube and a plurality of consumable fuel rods or wires running longitudinally through the outer tube. The semi-flattened outer tube of the cutting blade includes a pair of opposing relatively flat sides ideal for cutting relatively wide kerfs and a substantially flat top and bottom ideal for cutting narrower kerfs. By virtue of the semi-flattened outer tube and the closely packed and tightly sealed fuel wires surrounded thereby and running therethrough, flare outs, fluttering, side burns and wire stub outs can be more reliably avoided than in conventional cutting rods having cylindrical outer tubes.

### BACKGROUND OF THE INVENTION

1. Field of the Invention

This invention relates to an improved sacrificial exothermic cutting blade that is used in a standard oxygen exothermic cutting torch for cutting a variety of materials on land and underwater. The improved cutting blade is adapted to easily and reliably cut both wide and narrow kerfs by using different flat and curved portions of a semi-flattened outer tube.

2. Background Art

Exothermic cutting tools are employed on land and underwater for cutting structural materials such as rock, stone, concrete, iron and steel. Examples of conventional cutting rods are available by referring to U.S. Pat. Nos. 4,069,407; 4,182,947; 3,507,231; 3,487,791; 3,500,744; 3,507,230; 3,570,419; and 3,738,288. The exothermic cutting rods shown in the foregoing patents all have a cylindrical outer tube and a plurality of elongated fuel rods or wires held in place by tube crimps. The result is a rod of oxidizable metal used for cutting, gouging and piercing. Oxygen is driven through the cylindrical tube filled with wires, and the rod is subsequently ignited with a catalytic spark. The resulting flame is brought into contact with the structural material to be cut. Older exothermic cutting rods contained a mixture of steel and alloys like aluminum and magnesium to maintain combustion. The exothermic cutting rods commonly used today contain low carbon steel, allowing the flame to extinguish once oxygen flow is abated. Since oxygen is driven at 80 to 100 pounds psi through existing exothermic cutting rods to maintain combustion, single and multiple crimps are applied to the cylindrical outer tube to secure the internal fuel wires in position while the tube and wires are consumed during the cutting process. Wire combinations vary from a complete fill of the tube to a radial configuration with the center wire removed. Both designs experience problems in both cutting performance and reliability.

The tube crimps which secure the inner fuel wires unavoidably cause venturi-related effects. High pressure oxygen passing crimps causes vacuum-related turbulence. To counteract the negative consequences of uneven oxygen flow, oxygen pressures are typically elevated, exaggerating flare outs, fluttering, side burns and wire stub outs. In particular, the velocity of high pressure oxygen slows when encountering the crimps and rapidly increases after the crimps so as to cause an uneven vacuum. The greater the number of crimps, the greater the exaggerated negative effects. Since exothermic cutting rods contain multiple crimps to hold the fuel wires intact at high oxygen pressures, the exothermic flame suddenly stops, because oxygen turbulence disrupts and extinguishes the flame. One variation of flare outs is fluttering. In this case, the flame flutters which results in significantly reduced cutting efficiency and frequent flare outs. Uneven oxygen flow causes the cutting tube to burn unevenly up one side allowing oxygen to escape prior to the burn zone. Cutting efficiency is therefore significantly reduced and the rod is generally rendered unusable. Uneven oxygen flow causes inadequate combustion of the fuel wires leaving a portion of the wires protruding from the cutting end of the tube. The protruding wires prevent placing the exothermic cutting rod directly into the cutting kerf which renders the cutting rod unusable.

There is currently no method to narrow the cutting kerf because of the uniform diameter of the round tube. Round exothermic cutting rods cut a kerf (width) slightly larger than the diameter of the cylindrical rod. A ⅜ inch diameter round exothermic cutting rod will cut a slightly larger kerf in the hands of an experienced user. When users wish to cut a smaller kerf, a smaller diameter cutting rod is required which necessitates both additional inventory and that additional time be expended to exchange torch collets in order to be able to accommodate the new size.

### SUMMARY OF THE INVENTION

In general terms, an improved sacrificial exothermic cutting blade is described to be carried by a standard oxygen exothermic cutting torch for use in cutting structural materials on land and underwater. The cutting blade includes a semi-flattened outer tube at a first end thereof having a substantially oval shape such that a major axis along the height of the tube is longer than a minor axis along the width. The cutting blade includes a short cylindrical portion at its opposite end to be received by a collet of the torch. A plurality of conventional consumable fuel rods or wires runs longitudinally through the flattened outer tube of the rod.

Because of its semi-flattened shape, the outer tube of the rod has curved (i.e., rounded) top and bottom cutting surfaces and relatively flat side cutting surfaces. By virtue of the foregoing, the improved cutting blade has the ability to reliably cut a narrow kerf using one of the curved top or bottom cutting surfaces or a wider kerf using one of the relatively flat side cutting surfaces. In this same regard, the improved exothermic cutting blade will consume less oxygen and experience less flare outs, fluttering, side bums and stub outs than conventional tubular cutting rods having a cylindrical outer tube.

### BRIEF DESCRIPTION OF THE DRAWINGS

FIGS. 1 and 2 show cross-sections of conventional tubular exothermic cutting rods having a cylindrical outer tube;

FIG. 3 is a cross-section taken along lines 3-3 of FIG. 4 showing an improved exothermic cutting blade having a semi-flattened outer tube;

FIG. 4 is a side view of the improved exothermic cutting blade shown in FIG. 3; and

FIG. 5 shows the improved exothermic cutting blade of FIGS. 3 and 4 coupled to one example of an oxygen exothermic torch.

### DESCRIPTION OF THE PREFERRED EMBODIMENT

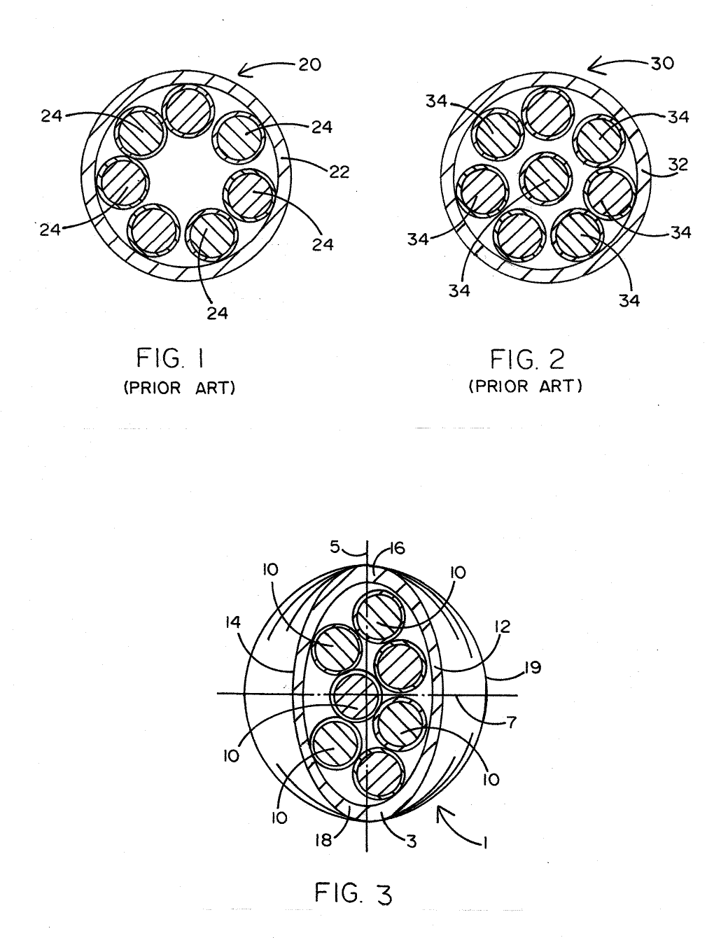

FIGS. 1 and 2 of the drawings illustrate cross-sections of conventional exothermic cutting rods 20 and 30. Each conventional cutting rod 20 and 30 has a cylindrical outer tube 22 and 32 and a plurality of correspondingly elongated inner fuel rods or wires 24 and 34 running therethrough. The conventional cylindrical cutting rods 20 and 30 have the characteristic disadvantages that were described hereinabove.

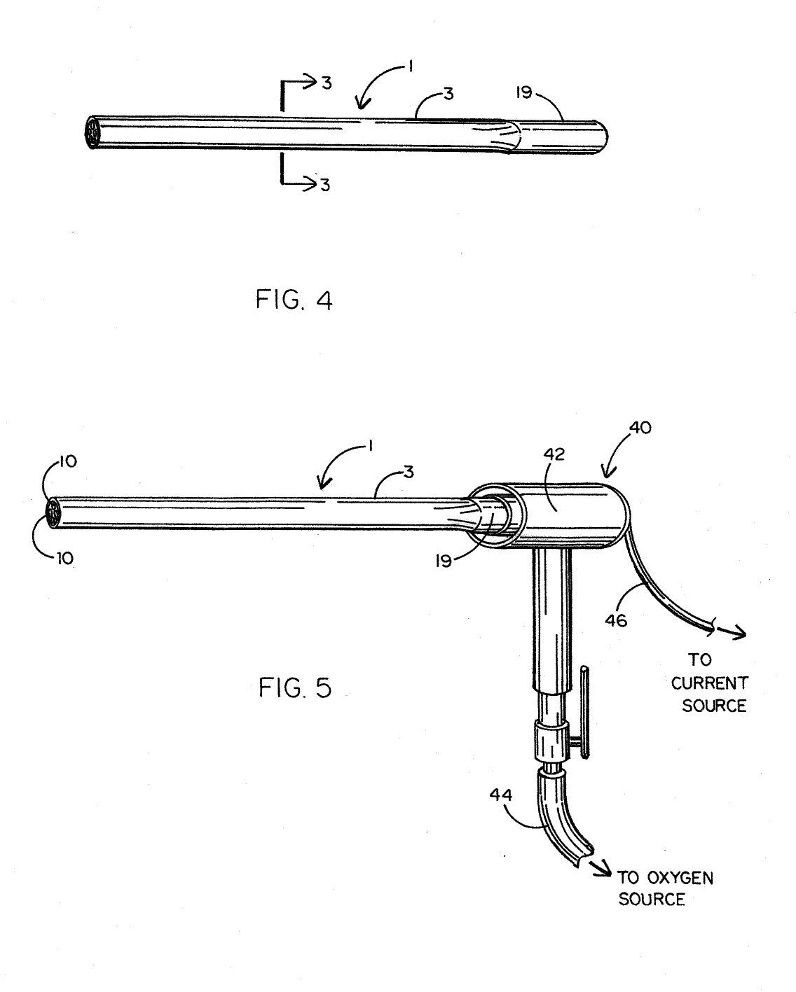

FIGS. 3 and 4 of the drawings illustrate an improved sacrificial exothermic cutting blade 1 in accordance with a preferred embodiment of this invention. Rather than having a cylindrical outer tube like that which is characteristic of the conventional cutting rods 20 and 30 of FIGS. 1 and 2, the cutting blade 1 of FIGS. 3 and 4 has a semi-flattened outer tube 3. That is to say, the outer tube 3 at one end of the cutting blade 1 has a substantially oval shape which, as best shown in FIG. 3, has a major axis 5 (i.e., a height) extending in a first direction which is longer than a minor axis 7 (i.e., a width) extending in a perpendicular second direction. A plurality of conventional consumable fuel rods or wires 10 extend longitudinally through the outer tube 3. The outer tube 3 is typically manufactured from copper clad steel or carbon so as to be consumed during use. It is to be understood that the height and width dimensions of the tube 3 as described herein are interchangeable with one another.

The semi-flattened outer tube 3 of cutting blade 1 is created by means of locating the usual cylindrical tube in a press and applying a compressive force to one end thereof until a desired flattened shape is achieved. The resulting cutting blade 1 has relatively flat side cutting surfaces 12 and 14 lying opposite one another and curved (i.e., rounded) top and bottom cutting surfaces 16 and 18 lying opposite one another. It is also to be understood that the locations of the sides of the blade 1 are interchangeable with the top and the bottom thereof. By way of one example only, the semi-flattened outer tube 3 has a height along its major axis 5 of about 10.0 mm and a width along its minor axis 7 of about 7.0 mm. The opposite end 19 of the cutting blade 1 remains cylindrical to fit within a standard torch collet (best shown in FIG. 5). The semi-flattening of the outer tube 3 creates a tight seal and holds the fuel rods or wires 10 in place with minimal turbulence, inasmuch as the circular pinching to which the conventional cylindrical outer tube is exposed is no longer required to hold the wires. The semi-flattened shape of the outer tube 3 permits different combinations of fuel rods or wires to run longitudinally therethrough. In the preferred embodiment shown in FIG. 3, the fuel wires 10 are packed close together and side-by-side in rows laying next to one another with the wires from one row seated against and between the wires of the adjacent row.

A significant advantage provided by the semi-flattened exothermic cutting blade 1 is its ability to cut a narrow kerf using a curved top or bottom cutting edge 16, 18 of the cutting blade or a wide kerf using a relatively flat side cutting edge 12, 14. By way of further example, a cutting blade like that shown in FIGS. 3 and 4 having a height along its major axis 5 of ⅜ inch can be efficiently used to cut either a narrow 3/16 inch kerf of a wide ⅜ inch kerf. This advantage will allow greater precision in effecting cuts, gouges and pierces using a single rod.

In addition to lower oxygen consumption, flare outs, fluttering, side burns and stub outs will be better avoided. The fuel wires 10 inside the semi-flattened tube 3 form a tight bundle seal against the tube walls which provides enhanced flow characteristics by virtue of the oxygen channels that are created during combustion. It has been found that the improved exothermic cutting blade 1 efficiently cuts ¼ inch material (e.g., both ferrous and non-ferrous metals) with as little as twenty pounds oxygen. Conventional cylindrical exothermic cutting rods are known to operate at eighty pounds oxygen pressure or greater merely to sustain combustion. The improved cutting blade 1 provides greater control and less oxygen consumption overall. The semi-flattened shape of the blade also allows for easier ignition because of its narrowed surface area across the burn horizon. As an additional benefit, the flattened shape of the outer tube 3 of cutting blade 1 prevents rolling along ship decks while being deployed in offshore cutting applications.

Comparative tests have shown that the improved exothermic cutting blade 1 of this invention facilitates making long cuts due to a focused linear flame configuration, while allowing low pressure cuts to be made with precision and longer burn duration. The economic advantages of the cutting blade 1 in terms of materials, labor, cutting performance and cutting reliability are significant and make the cutting blade ideally suited for repair, maintenance, scrap, dismantling and salvage assignments on land as well as in underwater marine settings.

FIG. 5 of the drawings shows a conventional oxygen exothermic torch 40 having a barrel 42 to which the cylindrical end 19 of the sacrificial exothermic cutting blade 1 is coupled. Combustible oxygen is supplied under pressure from a suitable source thereof by way of an oxygen supply hose 44. An electrical cable 46 runs from an electrical contact (not shown) at the rear of barrel 42 to a suitable current source (e.g., a 225 to 250 amp D.C. source). It is to be understood that the cutting blade 1 of this invention may be used with torches other than that shown in FIG. 5.

1. A sacrificial exothermic cutting rod to be coupled to a cutting torch to cut materials, said cutting rod comprising an outer tube and a plurality of consumable fuel wires extending longitudinally through and surrounded said outer tube, said fuel wires being positioned to create gas flow paths running through said tube, and wherein said outer tube has a first cutting surface that is curved and a second cutting surface that is curved less than said first cutting surface.

2. The sacrificial exothermic cutting rod recited in claim 1, wherein the second cutting surface of said outer tube is substantially flat.

3. The sacrificial exothermic cutting rod recited in claim 1, wherein said outer tube has a rounded top, a rounded bottom and a pair of substantially flat opposite sides, said first cutting surface lying at one of the rounded top or bottom of said outer tube, and said second cutting surface lying at one of the substantially flat opposite sides of said outer tube.

4. The sacrificial exothermic cutting rod recited in claim 1, wherein said outer tube has a height and a major axis running across said height and a width and a minor axis running across said width, wherein said major axis is longer than said minor axis and wherein the first cutting surface of said outer tube lies along said major axis and the second cutting surface of said outer tube lies along said minor axis.

5. The sacrificial exothermic cutting rod recited in claim 4, wherein there are a pair of opposing first cutting surfaces lying along the major axis of said outer tube, and there are a pair of opposing second cutting surfaces lying along the minor axis of said outer tube.

6. An exothermic cutting rod to be coupled to a cutting torch to cut materials, said cutting rod comprising an outer tube and a plurality of fuel wires extending longitudinally through and surrounded by said outer tube, said fuel wires being positioned to create gas flow paths running through said tube, and wherein said outer tube has at least one substantially round cutting surface and at least one substantially flat cutting surface.

7. The sacrificial exothermic cutting rod recited in claim 6, wherein said outer tube has a pair of opposing substantially round cutting surfaces and a pair of opposing substantially flat cutting surfaces.

8. The sacrificial exothermic cutting rod recited in claim 7, wherein said plurality of fuel wires extending longitudinally through said outer tube are arranged side-by-side one another in at least first and second rows with the first row of fuel wires located next to and laying against the second row of fuel wires.
